(19) United States
(12) Patent Application Publication
(10) Pub. No.: US 2004/0181677 A1
(43) Pub. Date: Sep. 16, 2004

(54) Method for detecting malicious scripts using static analysis

(75) Inventors: Man-Pyo Hong, Seongnam-City (KR); Sung-Wook Lee, Suwon-City (KR); Si-Haeng Cho, Seoul (KR); Byung-Woo Bae, Sacheon-City (KR); Hyung-Joon Lee, Gokseong-Gun (KR)

Correspondence Address: ROCCO S. BARRESE, ESQ., DILWORTH & BARRESE, LLP, 333 Earle Ovington Blvd., Uniondale, NY, 11553, US

(73) Assignee: Daewoo Educational Foundation

(21) Appl. No.: 10/697,756

(22) Filed: Oct. 30, 2003

(30) Foreign Application Priority Data
Mar. 14, 2003 (KR) 2003-16207

(51) Int. Cl. G06F 12/14

(52) U.S. Cl. 713/188

(57) ABSTRACT

The present invention relates to a method for detecting malicious scripts using static analysis. The method of the present invention comprises the step of checking whether a series of methods constructing a malicious code pattern exist and whether parameters and return values associated between the methods match each other. The checking step also comprises the steps of classifying, by modeling a malicious behavior in such a manner that it includes a combination of unit behaviors each of which is composed of sub-unit behaviors or one or more method calls, each unit behavior and method call sentence into a matching rule for defining sentence types to be detected in script codes and a relation rule for defining a relation between patterns matched so that the malicious behavior can be searched by analyzing a relation between rule variables used in the sentences satisfying the matching rule; generating instances of the matching rule by searching for code patterns matched with the matching rule from a relevant script code to be detected, extracting parameters of functions used in the searched code patterns, and storing the extracted parameters in the rule variables; and generating instances of the relation rule by searching for instances satisfying the relation rule from a set of the generated instances of the matching rule.

### BACKGROUND OF THE INVENTION

1. Field of the Invention

The present invention relates to a method for detecting malicious scripts, and more particularly, to a method for detecting patterns of malicious behavior using static analysis.

2. Description of the Prior Art

Malicious scripts are malicious codes written in script languages, and most of them have been spread via a medium such as a mail and IRC (Internet Relay Chat) in the form of an Internet worm. Script languages such as Visual Basic Script and JavaScript are frequently used to write malicious codes. Since the script languages are relatively simple and very easy for a beginner to learn, the beginner who has no professional knowledge of computers can easily generate malicious script codes. Furthermore, a generator for automatically generating malicious scripts has been recently spread via the Internet.

A signature-based scanning method is widely used to detect these malicious scripts as well as malicious binary codes. Since this technique can detect only malicious codes from which signatures are extracted through analysis, heuristic analysis is mainly used to detect new unknown malicious scripts. The heuristic analysis can be classified into static heuristic analysis for searching for code fragments frequently found in malicious codes through code scanning and dynamic heuristic analysis for determining maliciousness of code through the analysis of behavior patterns discovered through the emulation. Actually, since the detection of malicious behavior through the emulation requires a great deal of time and system resources, the static heuristic analysis is most frequently used.

However, it is very difficult to find out fixed code blocks, which perform malicious behavior, from malicious scripts existing in the form of source codes, unlike the malicious binary codes. Therefore, the static heuristic analysis for the malicious scripts employs a method for checking the presence or frequency of occurrence of specific words such as method calls and attributes. The biggest problem in the method for detecting malicious scripts is a high false alarm rate. In other words, since most of the methods used in malicious behavior can also be frequently used in normal scripts, false positive that the methods are actually not malicious codes but regarded as malicious codes may frequently occur. Thus, current static heuristic analysis abandons the detection of malicious behavior that is expected to have high false positive and is used only to detect some malicious codes consisting of specific method calls which are seldom used in normal scripts.

In the meantime, typical malicious behavior performed by malicious script codes includes self-replication for local systems or networks. In addition, malicious behavior such as transformation of system registries or other existing files may be performed. The malicious behavior performed by the malicious scripts are summarized and listed in Table 1 below.

TABLE 1

| Classification | Malicious behavior |
|---|---|
| Self-replication | Self-replication into local systems |
| | Self-replication through mails |
| | Self-replication using IRC programs |
| | Self-replication through network share folders |
| Change of system | Change of registries |
| information | |
| Modification of file | Modification of data files |
| | Modification of application setting |

Considering contents for each malicious behavior, the self-replication through mails is generally performed in such a manner that an address list of MicroSoft Outlook is referenced and a mail with file containing malicious script codes attached thereto is then sent to the referenced addresses. The self-replication through IRC programs is performed in such a manner that a script file of an IRC client program is changed and then automatically forwarded to other users during chatting. The change of system information is performed for the purpose of automatically executing a relevant script at the time of system rebooting by changing the registries of the system. The most basic features of the malicious codes are self-replication capability to create their own images repeatedly or propagate themselves while they are parasitic on the other files. Therefore, a main pattern that is searched for the detection of the malicious scripts is the self-replication. The malicious behavior such as modification or deletion of data files is an additional property of malicious code to be detected.

In fact, if only fundamental components of the Visual Basic Script or the JavaScript system are used, it is impossible to have access to resources needed for performing the malicious behavior. Therefore, to have access to these system resources, it is necessary to use COM or ActiveX objects listed in Table 2 below.

TABLE 2

| Object | Use |
|---|---|
| Scripting.Filesystem | Input/output of files and its related matters |
| WScript.Shell | Windows system information |
| WScript.Network | Use of network drive |
| Outlook.Application | Mail sending and its related matters |

The object ‘Scripting.Filesystem’ is used to perform the self-replication into a local file system. This object supports methods mainly relevant to input/output of files and can be used to write script codes for performing operations such as file copy, file create, file delete and the like. The object ‘Wscript.Shell’ is used to modify Windows system information or to drive new processes. This object supports methods for managing Windows system registry information, methods for driving new processes, and methods for manipulating other environment setting values. The malicious scripts causes themselves to be automatically executed at a specific time such as a starting time of system by using the registry-related methods supported by this object, and they may also execute a malicious program such as Trojan horse by using the methods for driving the new processes. The object ‘Outlook.Application’ is used for the propagation via an electronic mail. The malicious scripts read the address list by using methods and attributes of this object and create/send a new mail to which the malicious scripts themselves are attached.

In the conventional method for detecting the malicious scripts, techniques for the binary codes may be generally either used as they are or slightly modified to be suitable to the scripts in the form of source program. Such conventional techniques for detecting the malicious scripts can be summarized as shown in FIG. 1. The techniques can be classified into a direct method for determining the maliciousness of a relevant code by analyzing the code before execution and an indirect method for observing and determining malicious behavior and results occurring during or after execution, according to a detection time. Alternatively, the techniques can be classified into a scanner for searching for a specific pattern through code scanning, a behavior monitor for monitoring a behavior pattern of a relevant code through emulation or actual execution, and an integrity checker for checking the modification of files, according to data sources corresponding to the basis of determining the maliciousness of code.

Signature recognition through code scanning is the most common method for detecting the malicious codes. Since this method determines whether a relevant code is malicious by searching for special character strings existing only in a single malicious code, it has an advantage in that the speed of determination is high and the kinds of malicious code can be clearly discriminated. However, since this method hardly copes with unknown malicious codes, many users cannot help being exposed to the unknown malicious codes until any anti-virus system provider distributes a new database including signatures of those malicious codes and treatment for the relevant malicious codes. In particular, since most of the malicious scripts are generally propagated via the e-mail, IRC, network sharing, and the like, they are greatly harmful due to their high propagation speed.

The heuristic analysis has been conceived from the fact that new malicious codes frequently appear but new techniques for treating the malicious behavior seldom appear. New techniques for performing specific functions in general programs have developed by some leading programmers or scholars, whereas most programmers make programs based on the techniques so known. Since the malicious codes are also programs, new techniques for performing malicious behavior are disclosed by some leading malicious code manufacturers, and then, a plurality of malicious codes using the new techniques appear. Therefore, many new malicious codes including the known malicious behavior can be detected by analyzing given codes using heuristics for the known techniques for the malicious behavior.

These heuristic analysis techniques are classified into a technique using static heuristic analysis for the types of codes existing in malicious codes and a technique using dynamic heuristic analysis for behavior obtained during execution through emulation. The static heuristic analysis corresponds to a method for detecting malicious codes by organizing code fragments frequently used in malicious behavior into a database and scanning a relevant code to determine the presence and frequency of occurrence of the code fragments. Although this method exhibits relatively high scan speed and high false alarms, it has a disadvantage in that false positive rate is somewhat high. The dynamic heuristic analysis corresponds to a method for detecting malicious behavior by monitoring variations in system calls and system resources generated during the execution of programs while executing a relevant code on an emulator in which a virtual machine has been implemented. To this end, however, a complete virtual machine should be implemented. Further, there is a disadvantage in that all program flow cannot be searched by only one emulation. Particularly, since an emulator for script codes should include not only hardware and an operating system but also the related system objects and a variety of environments, it is difficult to implement the emulator and load imposed on the emulator is also large.

Behavior blocking can be considered as similar to the detection method using the dynamic heuristic analysis except that codes are actually executed in a relevant system. However, the emulation can determine the maliciousness of a relevant code through behavior monitoring during a long period of time without any side effects. On the other hand, the malicious behavior happens actually if the same behavior monitoring is performed while executing the malicious codes in a real system. Thus, the actual execution of the malicious codes should be immediately stopped when each behavior, such as disk format or system file modification, that is very likely to be executed by the malicious codes is detected. In the behavior blocking, therefore, it is difficult to monitor a pattern of behavior during a long period of time as in the emulation and warning is produced whenever each malicious behavior happens. As a result, a very high false positive occurs.

Integrity checking corresponds to an indirect malicious code detection method for recording file information on and checksums or hash values for all or part of files existing in a local disc and then checking whether the files have been modified after a predetermined time. This method detects only the modification of specified files, and thus, it has a disadvantage in that a very high false positive appears in a case where it is used for files in which variations in legitimate contents are expected. Therefore, this method can be generally applied to some system files for the purpose of detecting the modification of files due to malicious codes or system intrusion on a server.

Due to the disadvantages of the aforementioned behavior blocking and integrity checking, the static heuristic analysis becomes accepted as a method that is most practical in the detection of the malicious scripts among the malicious code detection methods. This static heuristic analysis is used in such a manner that the presence or frequency of occurrence of specific words such as method calls and attributes are checked in consideration of the peculiarity of scripts. At this time, the method calls and attributes to be checked can mainly appear in the codes for performing self-replication. It can be regarded as a problem of understanding programmer's intention to determine whether given codes are either normal ones or malicious ones. As a criterion of the determination, it is most commonly used to determine whether the relevant code has performed self-replication.

In other words, the malicious codes include self-replication routines due to their nature that they intend to perform the malicious behavior in as many systems as many as possible. However, since normal programs do not perform such self-replication, whether the self-replication routines are included can be used as the most essential determination criterion. That is, the determination on the maliciousness of a given code can be achieved by precisely determining whether the self-replication has been performed. However, since the respective methods for use in the self-replication behavior can be frequently used in the general scripts, simple determination on the presence of the methods may lead to a high false positive rate.

FIG. 2 shows an example of the static heuristic analysis employed by the conventional anti-viruses. A part of a malicious code for causing the love letter worm itself to be sent via an electronic mail is shown in the right side of FIG. 2. However, the static heuristic analysis does not determine whether the self-replication is actually performed via the electronic mail but determines the maliciousness of the love letter worm by checking only the presence of the methods and attributes illustrated in the left side of FIG. 2. In such a case, all scripts having five words in the left top or four words in the left bottom of FIG. 2 will be regarded as malicious scripts. Therefore, a false positive happens that legitimate scripts, which have access to an address list and generate and send a mail, are regarded as the malicious scripts. However, since there are few cases where the scripts for sending the mail obtain access to the address list, this example can be regarded as a case where the false positive rate is relatively low.

A critical case can be confirmed through another example of the script codes for performing the self-replication in a system as shown in FIG. 3. Referring to FIG. 3, an illustrated script code performs the self-replication in a local system by overwriting its own content onto all the VBS files in the system. Even though this code performs the malicious behavior of turning all the VBS files in the system into the malicious non-malicious scripts, it consists of only the methods, such as file open and folder list open, frequently used in many scripts. Thus, if it is checked only as to whether the specific words exist, an extremely high false positive rate appears. Accordingly, most of the anti-virus systems does not detect the malicious behavior that is expected to have a high false positive, but restrictively detects several malicious codes consisting of specific method calls that are seldom used in the general scripts. Finally, since the actual malicious scripts do not include all known malicious behaviors, it is difficult to detect the malicious behavior and to determine the maliciousness when the malicious scripts using the only frequently used method calls appear.

### SUMMARY OF THE INVENTION

The present invention is conceived to solve the problems in the prior art. Accordingly, an object of the present invention is to provide a method for detecting malicious scripts with high accuracy through precise static analysis.

According to an aspect of the present invention for achieving the object, there is provided a method for detecting malicious scripts using a static analysis, comprising the step of checking whether a series of methods constructing a malicious code pattern exist and whether parameters and return values associated between the methods match each other, wherein the checking step comprises the steps of classifying, by modeling a malicious behavior in such a manner that it includes a combination of unit behaviors each of which is composed of sub-unit behaviors or one or more method calls, each unit behavior and method call sentence into a matching rule for defining sentence types to be detected in script codes and a relation rule for defining a relation between patterns matched so that the malicious behavior can be searched by analyzing a relation between rule variables used in the sentences satisfying the matching rule; generating instances of the matching rule by searching for code patterns matched with the matching rule from a relevant script code to be detected, extracting parameters of functions used in the searched code patterns, and storing the extracted parameters in the rule variables; and generating instances of the relation rule by searching for instances satisfying the relation rule from a set of the generated instances of the matching rule.

Preferably, the matching rule is composed of rule identifiers and sentence patterns constructing malicious behavior and having the same grammar as a language of the scripts to be detected, and wherein the relation rule comprises conditional expressions (Cond) in which conditions satisfying the relevant rule are described, and action expressions (Action) in which contents to be executed are described when the conditions in the conditional expressions are satisfied.

### BRIEF DESCRIPTION OF THE DRAWINGS

The above and other objects, features and advantages of the present invention will become more apparent from the following description of a preferred embodiment given in conjunction with the accompanying drawings, in which:

FIG. 1 is a diagram illustrating a related art malicious code detection technique;

FIG. 2 shows an example of static heuristic analysis employed by conventional anti-viruses;

FIG. 3 shows an example of script codes that performs self-replication in a conventional system;

FIG. 4 shows an example of a Visual Basic Script code that performs self-replication via a mail for explaining a concept of the present invention;

FIG. 5 shows an example of rule description syntax written in BNF according to the present invention;

FIG. 6 shows an example of a rule for detecting local replication behavior according to the present invention;

FIG. 7 shows an example of a rule for detecting the attachment and sending of a local replica according to the present invention;

FIG. 8 shows an example of a rule for detecting propagation behaviors via IRC according to the present invention; and

FIG. 9 is a flowchart illustrating a static analysis process according to the present invention.

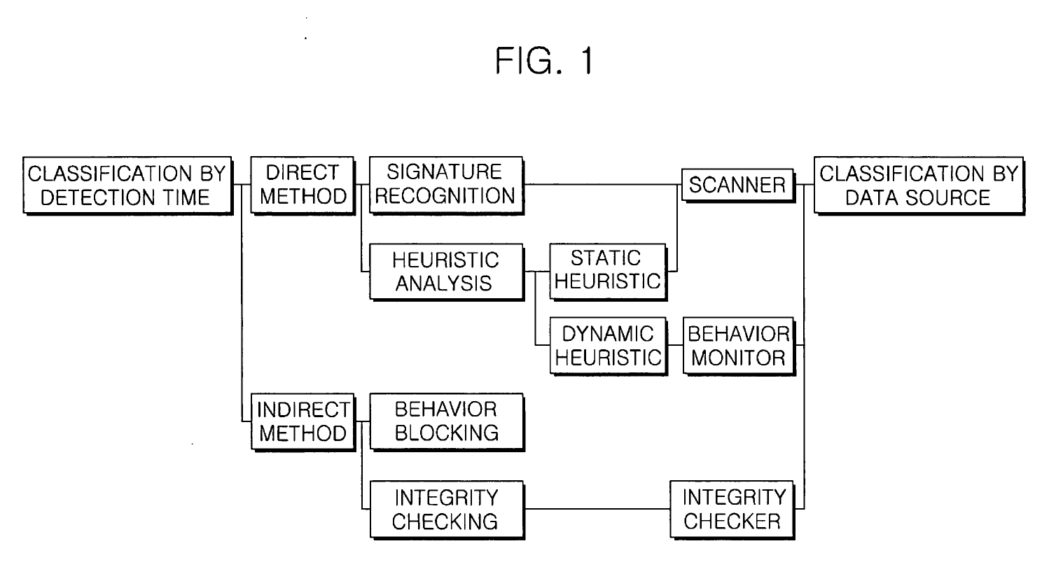

### DESCRIPTION OF THE PREFERRED EMBODIMENT

Hereinafter, the present invention will be described in detail with reference to the accompanying drawings.

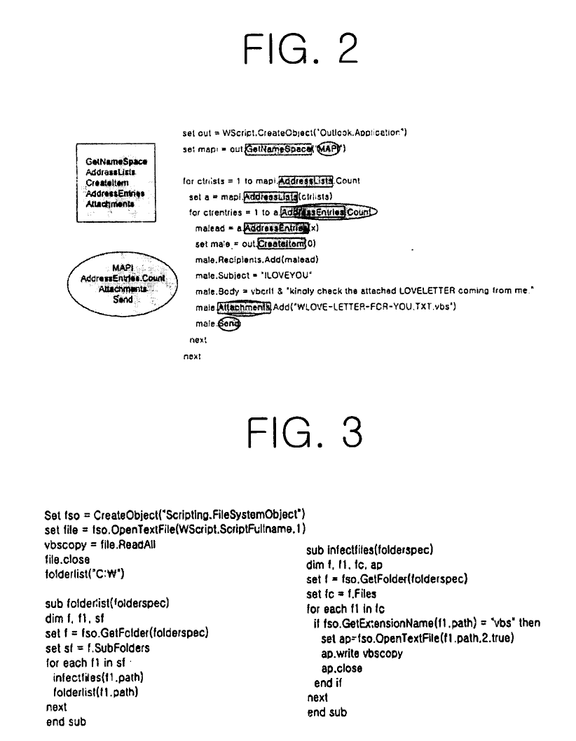

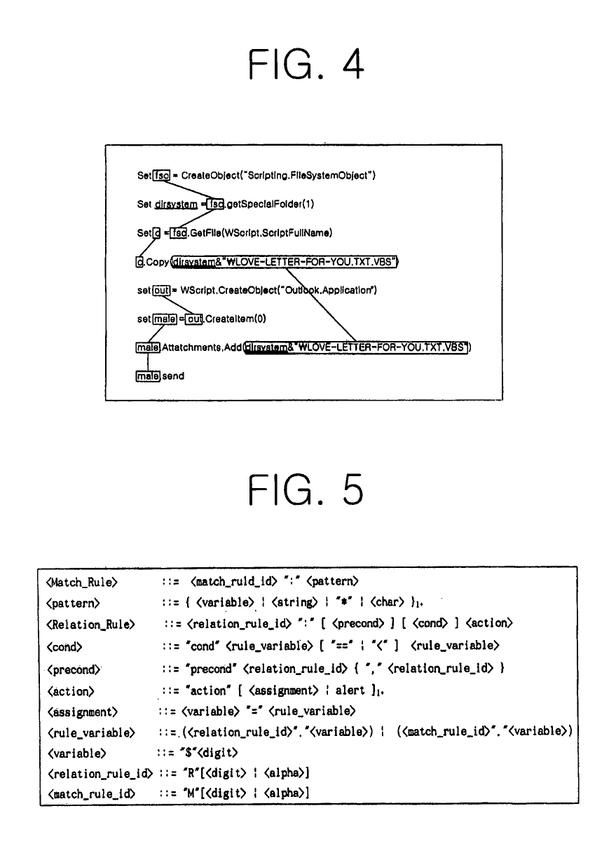

FIG. 4 shows an example of a Visual Basic Script code that performs self-replication via electronic mail for explaining the concept of the present invention. This code corresponds to some main sentences extracted from a self-replication code pattern as shown in FIG. 2. As can be seen from FIG. 4, if a plurality of method calls is to establish any one malicious behavior, a special relationship should be necessarily maintained between their parameters and return values. For example, a ‘Copy’ method in the fourth row copies a currently executing script into a file having a name of ‘LOVE-LETTER-FOR-YOU.TXT.VBS’ and an ‘Attachments.Add’ method in the seventh row attaches the copied file to a newly created mail object, so that the self-replication via mail can be accomplished.

However, if a method for checking only the presence of the method calls is employed, when irrelevant method calls are present, for example, a code containing any irrelevant method call for creating a script file ‘A’ and then attaching a file ‘B’ to the file ‘A’ may be regarded as a malicious code. Thus, it results in a high false positive. In other words, a script code in which the same file ‘LOVE-LETTER-FOR-YOU.TXT.VBS’ is copied in fourth row of FIG. 4 but a completely irrelevant file ‘MYPIC.JPG’ is attached to the mail in seventh row of FIG. 4 should not be determined as a code for performing the self-replication via mail. In this context, the checking for other variables can be understood in the same manner as the foregoing. For example, ‘c’ in the third row has a file handle of a relevant script and creates a local replica through the ‘Copy’ method call in the fourth row. However, if a script in which the ‘Copy’ method call is an irrelevant method call of a completely different file object such as ‘d.copy . . . ’ has been given, it can be determined that the execution of this script is not the self-replication but merely corresponds to the copy of the completely different irrelevant file.

On the other hand, the conventional static heuristic analysis determines whether codes for performing the self-replication exist based only on the presence of a method call sequence usable for the self-replication. For example, if a script for sending a user's own photograph to respective objects included in an address list is given, the conventional static heuristic analysis determines this script as a malicious code since a method sequence for performing the address list search and mail sending is found. However, the detection method of the present invention is configured to reference the parameters and return values of the method sequence constructing the malicious behavior. Therefore, if a file attached to a mail is not the script itself or its replica, this behavior is not regarded as malicious behavior. In the example shown in FIG. 4, the present invention checks whether used file names and all relevant values such as ‘fso’, ‘c’, ‘out’ and ‘male’ as well as the presence of method calls match one another and thus can obtain more accurate detection results than those in a simple character string search. Although the method of the present invention is similar to the conventional methods in that it basically uses heuristics for malicious behavior, there is a difference in that it performs precise analysis similar to code static analysis for use in program analysis in the field of software engineering or compiler optimization.

In practice, this malicious behavior cannot be defined by only a series of method sequences, but is composed of a combination of various methods or method sequences. Therefore, in the present invention, the malicious behavior is modeled to be composed of a combination of unit behaviors each of which is composed of sub-unit behaviors or at least one method call, and each unit behavior and a method call sentence is expressed as a single rule.

Here, a rule for a pattern of malicious behavior is classified into a matching rule for defining sentence types to be detected in the script codes and a relation rule for defining a relation between the matched patterns. FIG. 5 shows such a rule description syntax written in BNF. Referring to FIG. 5, ‘<Match_Rule>’ is a matching rule and comprises rule identifiers and patterns to be detected. The identifiers start with ‘M’ to which the kind and number of rules are appended. The patterns to be detected correspond to sentence patterns constructing the malicious behavior and have the same grammar as a language of the script to be detected. However, parameters and return values used in the respective methods can be replaced by rule variables so that these rule variables can be used in different rules. ‘<Relation_Rule>’ means a relation rule and is used to search for the malicious behavior by analyzing a relation between the rule variables used in the sentences satisfying the matching rule. The relation rule comprises conditional expressions (Cond) in which conditions satisfying a relevant rule are described, and action expressions (Action) in which contents to be executed are described when the conditions in the conditional expressions are satisfied. Alternatively, the relation rule may further include preconditions (Precond) in which conditions that should be satisfied prior to the conditions in the conditional expressions are described, if necessary. Then, any one rule is satisfied when the rule described in the preconditions has been already satisfied and the contents described in the conditional expressions are true. At this time, the contents in the action expressions will be executed.

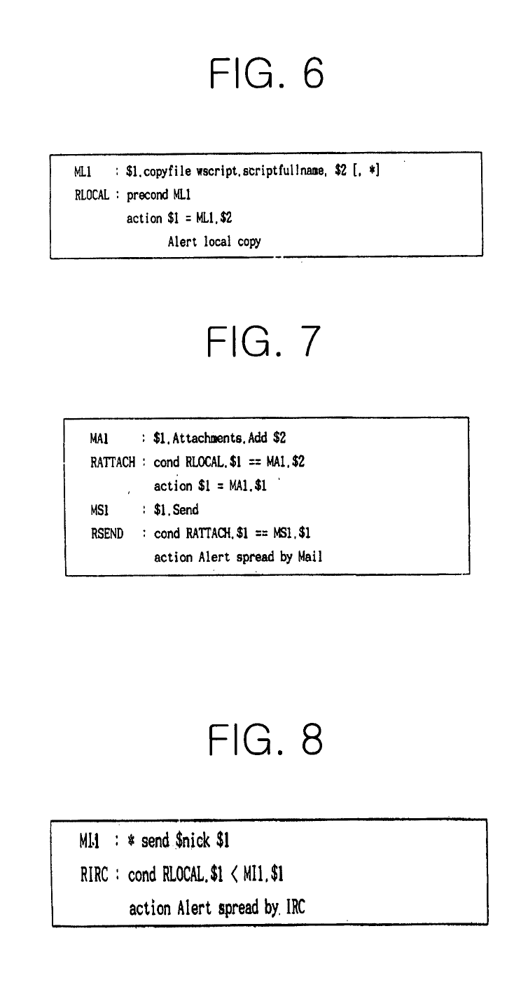

Meanwhile, a variety of types of malicious behaviors may exist in the malicious scripts as described above, but the most essential malicious behavior will be the self-replication in the nature of the malicious codes. Therefore, an example of a rule for a pattern of malicious behavior will be now described regarding the self-replication behavior. The self-replication on a local system is most basic malicious behavior, and the malicious script is copied onto a local disc. FIG. 6 shows an example of a rule for detecting local replication behavior according to the present invention. Referring to FIG. 6, when a sentence of the form described in ‘ML1’ is found from a script in the course of actual static analysis, an instance of a relevant rule is generated to record that the rule has been satisfied, and character strings corresponding to ‘$1’ and ‘$2’ are stored in the instance. Further, in the subsequent relation analysis step, ‘RLOCAL’ is revealed to be a rule satisfied automatically when ‘ML1’ is satisfied and a value ‘$2’ of ‘ML1’ is stored. The contents in a portion marked as ‘[ ]’ in ‘ML1’ of the figure may not be present since they are optional. The portion is disregarded for precise parameter analysis if a form in the bracket appears. In the end, local self-replication patterns defined through the aforementioned procedures are detected and a name of the copied file is stored in a rule variable ‘RLOCAL.$1’ so that information on the detected patterns can be used in the other rules.

The self-replication via mail corresponds to behavior for attaching a file copied in the local system or an original file to a mail and sending the mail. FIG. 7 shows an example of a rule for searching the attachment and sending of a local replica according to the present invention, i.e. an example of a rule for detecting the self-replication via mail. It can be seen from this figure that the rule includes a portion for attaching the copied file to the mail and a portion for sending the mail. ‘MA1’ and ‘MS1’ represent behavior for attaching the copied file to the mail and a code for sending the mail, respectively. ‘RATTACH’ is satisfied when file names of the ‘MA1’ and the local replication behavior detection rule ‘RLOCAL’ match each other. ‘RSEND’ is satisfied only when the behavior for attaching the file to the mail, ‘RATTACH’, and the mail sending behavior, ‘MS1’ are present and the mail sending object and file attachment object match each other.

An IRC program, which is one of the chatting programs most frequently used in the world, has a setting file to specify its own execution environment and event Many malicious scripts modify the setting file of the IRC program and automatically send a local replica or its own original file to chatting partners during chatting. FIG. 8 shows an example of a rule for detecting propagation behavior via IRC according to the present invention. An operator ‘<’ means checking whether a character string contained in a rule variable in the right side of the operator includes a character string contained in a rule variable in the left side of the operator. Accordingly, in this example, it is checked whether a file name of the local replica appears in a character string located after ‘send $nick’ in the script.

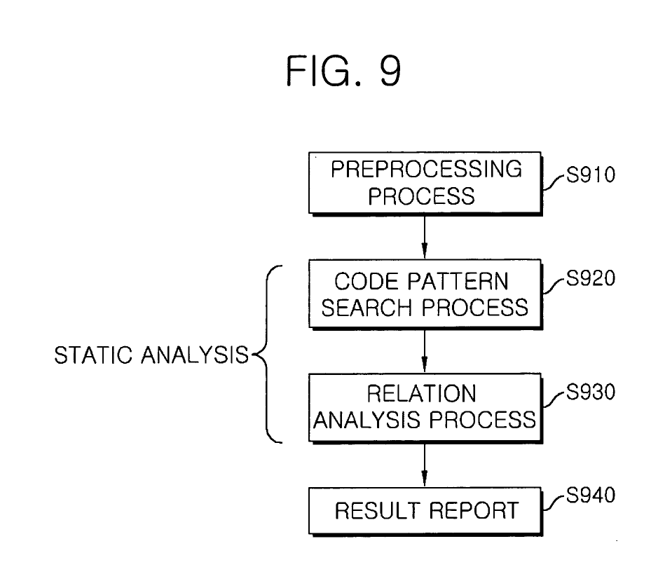

FIG. 9 is a process flow diagram illustrating the processes of the static analysis according to the present invention. Many malicious scripts exists in an encrypted format or uses a method of encoding some character strings into ASCII codes by using a function ‘chr&Ovalhollow;’ so that anti-viruses have difficulty in detecting the malicious scripts. Such encryption or encoding can be dealt with by using the heuristics and partial emulation, similar to the preprocessing procedures for the conventional static heuristic analysis. A given script is converted into a format suitable to the static analysis through the pre-processing procedures (S910). Next, an instance of the matching rule is generated (S920) by searching the converted script codes for code patterns matched with the matching rule through a code pattern search process, extracting parameters of the functions used in the searched code patterns and storing the extracted parameters in a rule variable. In other words, after the code pattern search process has been completed, the matching rule instance corresponding to each script sentence matched with a set of given matching rules is obtained.

Next, an instance of the relation rule is generated (S930) by searching for an instance of the matching rule satisfying the relation rule from the set of the generated instances of the matching rule through a relation analysis process. That is, similar to the code pattern search process, the relation rule instance is generated when each relation rule is satisfied. However, this relation analysis process is different from the code pattern search process in that it continuously checks whether other relation rules associated with the relevant relation rule are satisfied. The code pattern search process S920 and the relation analysis process S930 represent an essential static analysis process. Finally, the malicious behavior detected during the relation analysis process and the maliciousness of relevant code are reported to a user through a result report process (S940). Since most of the malicious scripts are in the form of worms existing as independent programs that is not parasitic on the other programs, the malicious behavior can be dealt with by deleting the relevant script file.

As described above, the method of detecting the malicious scripts using the static analysis can accurately detect a series of codes constructing the malicious behavior, thereby more precisely detecting the malicious behavior that has been seldom detected only by the conventional simple character string search. According to the present invention, therefore, the false alarms can be lowered more than the conventional methods in the case of the malicious behavior that can be detected by the conventional methods, whereas the malicious behavior can be detected even in the case of the malicious behavior that cannot be detected by the conventional methods.

Although the present invention has been described in detail in connection with the preferred embodiment of the present invention, it will be apparent to those skilled in the art that various changes and modifications can be made thereto without departing from the spirit and scope of the invention. Thus, simple modifications to the embodiment of the present invention fall within the scope of the present invention.

What is claimed is:

1. A method for detecting malicious scripts using a static analysis, comprising the step of:
checking whether a series of methods constructing a malicious code pattern exist and whether parameters and return values associated between the methods match each other,
wherein the checking step comprises the steps of:
classifying, by modeling a malicious behavior in such a manner that it includes a combination of unit behaviors each of which is composed of sub-unit behaviors or one or more method calls, each unit behavior and method call sentence into a matching rule for defining sentence types to be detected in script codes and a relation rule for defining a relation between patterns matched so that the malicious behavior can be searched by analyzing a relation between rule variables used in the sentences satisfying the matching rule;
generating instances of the matching rule by searching for code patterns matched with the matching rule from a relevant script code to be detected, extracting parameters of functions used in the searched code patterns, and storing the extracted parameters in the rule variables; and
generating instances of the relation rule by searching for instances satisfying the relation rule from a set of the generated instances of the matching rule.

2. The method according to claim 1, wherein the matching rule is composed of rule identifiers and sentence patterns constructing malicious behavior and having the same grammar as a language of the scripts to be detected, and wherein the relation rule comprises conditional expressions (Cond) in which conditions satisfying the relevant rule are described, and action expressions (Action) in which contents to be executed are described when the conditions in the conditional expressions are satisfied.

3. The method according to claim 2, wherein the relation rule further includes preconditions (Precond) in which conditions that should be satisfied prior to the conditions in the conditional expressions are described, and
the action expressions describe contents that will be executed when both the conditional expressions and the preconditions are satisfied.
